(19) United States
(12) Patent Application Publication
(10) Pub. No.: US 2026/0278853 A1
(43) Pub. Date: Sep. 17, 2026

(54) IMAGE PROCESSING SYSTEM, IMAGE PROCESSING APPARATUS, AND NON-TRANSITORY COMPUTER READABLE MEDIUM

(71) Applicant: FUJIFILM Business Innovation Corp., Tokyo (JP)

(72) Inventor: Hidetomo NAKAYAMA, Kanagawa (JP)

(73) Assignee: FUJIFILM Business Innovation Corp., Tokyo (JP)

(21) Appl. No.: 19/275,571

(22) Filed: Jul. 21, 2025

(30) Foreign Application Priority Data
Mar. 12, 2025 (JP) 2025-039475

(51) Int. Cl. G06T 11/00; G06V 10/44

(52) U.S. Cl. CPC G06T 11/00; G06V 10/44

(57) ABSTRACT

An image processing system includes a processor configured to: in a case where an image as a copyrighted material included in a document to be printed is replaced with a different image, extract a feature of the image; analyze a part other than the image in the document; and acquire, based on the extracted feature and a result of the analysis, the different image.

### CROSS-REFERENCE TO RELATED APPLICATIONS

This application is based on and claims priority under 35 USC 119 from Japanese Patent Application No. 2025-039475 filed Mar. 12, 2025.

### BACKGROUND

### (i) Technical Field

The present disclosure relates to an image processing system, an image processing apparatus, and a non-transitory computer readable medium. (ii) Related Art

An image processing apparatus including acquiring means for acquiring a document, first extracting means for extracting an element that requires copyright processing from among elements forming the acquired document, and second extracting means for extracting a condition of use of a copyright of the extracted element is described in, for example, Japanese Unexamined Patent Application Publication No. 2020-198015. The image processing apparatus also includes receiving means for presenting, for each element extracted, a condition of use corresponding to the element and receiving a designation as to whether or not to use the element. Furthermore, the image processing apparatus includes presenting means for adding a fee included in a condition of use corresponding to an element that is designated to be used to a fee for output of the document and presenting a total fee. The image processing apparatus further includes output means for, when the total fee is paid, generating output data by performing processing on an element designated not to be used, the processing complying with a condition of use corresponding to the element, and replacing the element with the processed element, and outputting the output data.

### SUMMARY

A case where an image as a copyrighted material in a document is replaced with a different image will be considered. In the case where there is some association between the image as the copyrighted material and a part other than the image in the document, if the different image that replaces the image as the copyrighted material is less associated with the part other than the image, the replacement adversely affects the association in the whole document.

Aspects of non-limiting embodiments of the present disclosure relate to, in a document including an image as a copyrighted material and a part other than the image, when the image as the copyrighted material is replaced with a different image, compared to a case where a configuration for taking into account an association between the different image that replaces the image as the copyrighted material and the part other than the image is not provided, guaranteeing the association in the whole document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing system including a processor configured to: in a case where an image as a copyrighted material included in a document to be printed is replaced with a different image, extract a feature of the image; analyze a part other than the image in the document; and acquire, based on the extracted feature and a result of the analysis, the different image.

### BRIEF DESCRIPTION OF THE DRAWINGS

Exemplary embodiments of the present disclosure will be described in detail based on the following figures, wherein:

FIG. 1 is a diagram for explaining an image processing system;

FIG. 2 is a diagram for explaining an example of the hardware configuration of a server;

FIG. 3 is a diagram illustrating an example of the hardware configuration of a printer;

FIG. 4 is a block diagram illustrating an example of the functional configuration of the printer;

FIG. 5 is a diagram for explaining a determination regarding a copyrighted material based on an image part and a body part of a document to be printed and generation of a replacement image;

FIG. 6-1 is a sequence diagram illustrating a sequence example in a first exemplary embodiment;

FIG. 6-2 is a sequence diagram illustrating the sequence example in the first exemplary embodiment;

FIG. 7A is a diagram for explaining a display example of an operation panel of the printer;

FIG. 7B is a diagram for explaining another display example of the operation panel of the printer;

FIG. 8A is a diagram for explaining a first printing example as a printed material in which a document to be printed is printed;

FIG. 8B is a diagram for explaining a second printing example as the printed material in which the document to be printed is printed;

FIG. 8C is a diagram for explaining a third printing example as the printed material in which the document to be printed is printed;

FIG. 9 is a diagram for explaining a display example of an operation panel in a second exemplary embodiment;

FIG. 10A is a diagram for explaining a display example of the operation panel in the second exemplary embodiment;

FIG. 10B is a diagram for explaining another display example of the operation panel in the second exemplary embodiment;

FIG. 11A is a diagram for explaining an application example in a case where a document includes a plurality of pages;

FIG. 11B is a diagram for explaining the application example and illustrates an example of each page in the document;

FIG. 12 is a diagram illustrating another example of each page in the document in the application example; and

FIG. 13 is a diagram for explaining an image processing system in a third exemplary embodiment.

### DETAILED DESCRIPTION

Hereinafter, exemplary embodiments of the present disclosure will be described in detail with reference to the attached drawings.

### System Configuration

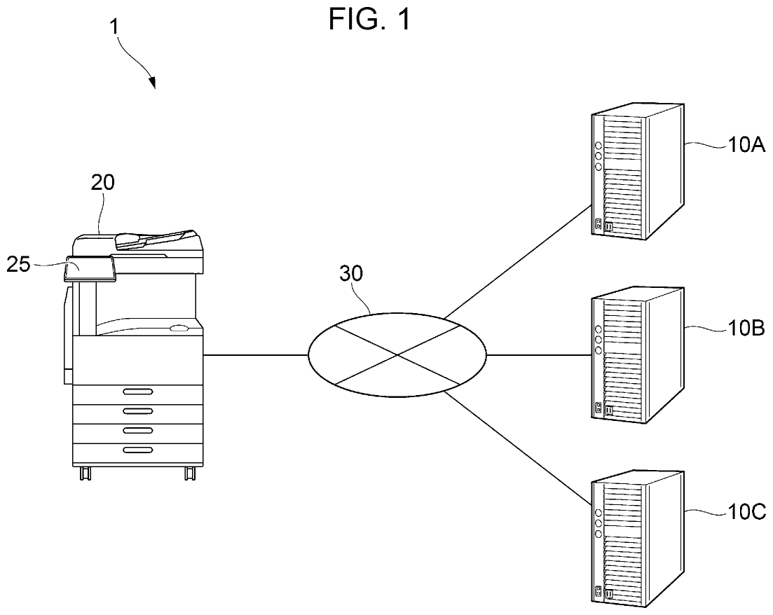

FIG. 1 is a diagram for explaining an image processing system 1.

The image processing system 1 illustrated in FIG. 1 includes servers 10A, 10B, and 10C that provide an image processing service and a printer 20 connected to a network 30. The printer 20 is an example of an image processing apparatus.

A user of an image processing service is able to cause the printer 20 to perform printing of a document. Printing of a document is copying of a document. However, printing of a document may be printing of document data.

In the case of printing of document data, document data created using an application is transmitted from a user terminal, which is not illustrated in FIG. 1, that is connected to the network 30. The user terminal, which is not illustrated in FIG. 1, is, for example, a desktop computer.

In the case where a document the user wishes to print includes an image, the server 10A determines whether or not the image is a copyrighted material. In the case where it is determined that the image is a copyrighted material and duplication of the copyrighted material is not performed, the servers 10B and 10C are involved in generation of a different image that will replace the image as the copyrighted material. Replacement of an image represents replacing the image as the copyrighted material with a replacement image.

Hereinafter, a different image that replaces an image as a copyrighted material will be referred to as a “replacement image.” A different image that replaces an image as a copyrighted material may also be regarded as a substitute image.

In printing of a document, the printer 20 replaces an image as a copyrighted material with a replacement image. That is, the printer 20 performs printing of print data in which an image part in a document is replaced with a replacement image and no change is made to a part other than the image in the document.

The part other than the image part in the document will be referred to as a “body part.”

The servers 10A to 10C illustrated in FIG. 1 are cloud servers. The servers 10A to 10C each include one or a plurality of servers. The servers 10A to 10C generate, using artificial intelligence (AI), output data based on input data.

The server 10A is an image determination AI that determines whether or not an image included in a document is a copyrighted material. That is, the server 10A performs an image determination as to whether or not an image corresponds to a copyrighted material.

Furthermore, the server 10A extracts a feature of an image. The server 10A transmits a determination result and the extracted feature of the image to the printer 20.

The server 10B is a text determination AI that performs a text determination on the body part of a document. The server 10B transmits a determination result to the printer 20.

The server 10C is an image generation AI that generates a replacement image. The server 10C transmits the generated replacement image to the printer 20.

The servers 10A, 10B, and 10C will be generically referred to as “servers 10.”

The printer 20 is an apparatus that includes at least a function for printing a document on paper. In this respect, the printer 20 may also be regarded as an image forming apparatus. The printer 20 may be an apparatus dedicated to printing. However, the printer 20 may include other functions such as duplication (so-called copying), document reading (scan), and facsimile (FAX).

### Configuration of Servers

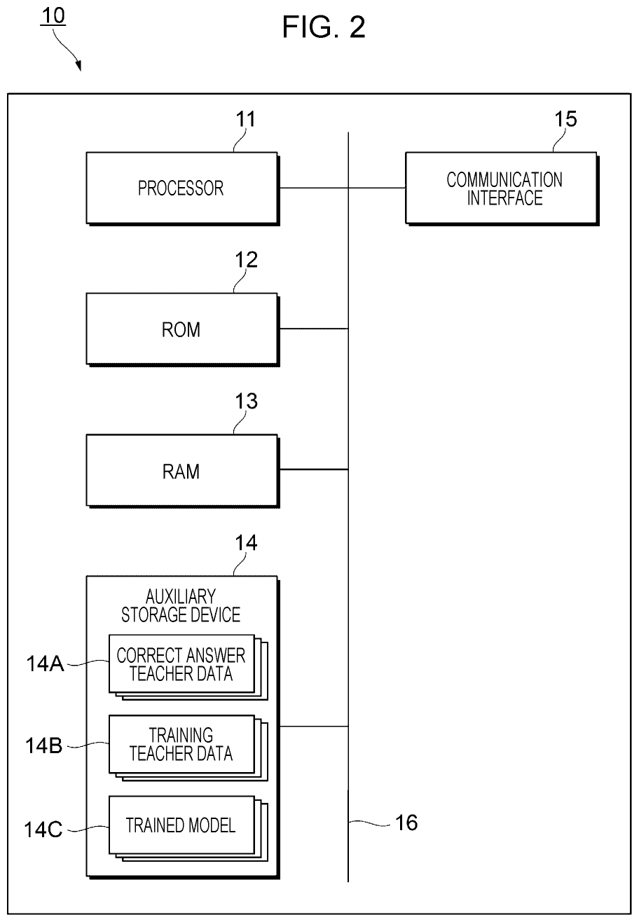

FIG. 2 is a diagram for explaining an example of the hardware configuration of a server 10.

The server 10 illustrated in FIG. 2 includes a processor 11 and a read only memory (ROM) 12 in which, for example, a basic input output system (BIOS) is stored. Furthermore, the server 10 includes a random access memory (RAM) 13 that is used as a work area of the processor 11. The server 10 further includes an auxiliary storage device 14 and a communication interface 15. The devices mentioned above are connected via a signal line 16 such as a bus.

The processor 11 is a device that implements various functions through execution of a program. The processor 11, the ROM 12, and the RAM 13 function as a computer.

The communication interface 15 is an interface that implements communication with the printer 20. The communication interface 15 supports various communication standards. The communication standards include, for example, Ethernet (registered trademark), Wi-Fi (registered trademark), and a mobile communication system.

The auxiliary storage device 14 includes, for example, a hard disk device and a semiconductor storage. Programs and various data are stored in the auxiliary storage device 14. An operating system (OS) and an application program will be generically referred to as programs.

In the case of the server 10, a program for providing an image processing service is one of application programs.

Data necessary for provision of the image processing service are also stored in the auxiliary storage device 14. In the case illustrated in FIG. 2, correct answer teacher data 14A, training teacher data 14B, and a trained model 14C are stored in the auxiliary storage device 14.

Data corresponding to roles for provision of the image processing service are stored in the server 10A, the server 10B, and the server 10C (see FIG. 1). The image processing service is provided in cooperation among the server 10A, the server 10B, and the server 10C.

For example, teacher data for discriminating between an image as a copyrighted material and an image as a non-copyrighted material is stored in the auxiliary storage device 14 of the server 10A as the image determination AI.

In the server 10A, the correct answer teacher data 14A is data that has verified that an image is a copyrighted material. The training teacher data 14B is teacher data for machine learning generated based on the correct answer teacher data 14A. The trained model 14C is a trained model that aids the determination as to whether or not an image is a copyrighted material.

Furthermore, the server 10A extracts a feature of an image that is determined to be a copyrighted material. For example, teacher data for extracting a feature of an image is stored in the auxiliary storage device 14 of the server 10A.

The correct answer teacher data 14A in the server 10A is verified data indicating that a feature of an image has been extracted and verified. The training teacher data 14B is teacher data for machine learning generated based on the correct answer teacher data 14A. The trained model 14C is a trained model that aids extraction of a feature of an image.

For example, teacher data for analyzing the body part of a document is stored in the auxiliary storage device 14 of the server 10B as the text determination AI. In this analysis, elements are extracted from, for example, a title of the document. The analysis is performed by obtaining, from the extracted elements, an element corresponding to a predetermined feature and a feature element quantity of the element.

In the server 10B, the correct answer teacher data 14A is verified data that has verified analysis of the body part of a document. The training teacher data 14B is teacher data for machine learning generated based on the correct answer teacher data 14A. The trained model 14C is a trained model that aids analysis of the body part of the document.

For example, teacher data for generating a replacement image based on a feature extracted by the server 10A and the result of analysis by the server 10B is stored in the auxiliary storage device 14 of the server 10C as the image generation AI.

In the server 10C, the correct answer teacher data 14A is verified data that has verified a replacement image created based on a feature and an analysis result. The training teacher data 14B is teacher data for machine learning generated based on the correct answer teacher data 14A. The trained model 14C is a trained model that aids creation of the replacement image based on the feature and the analysis result.

A case where, as described above, for example, teacher data for determining whether or not an image as a determination target is a copyrighted material is stored in the auxiliary storage device 14 of the server 10A has been explained. However, the present disclosure is not limited to this configuration. That is, for example, teacher data for determining the degree of similarity between an image as a determination target and a copyrighted material may be stored in the auxiliary storage device 14.

### Hardware Configuration of Printer

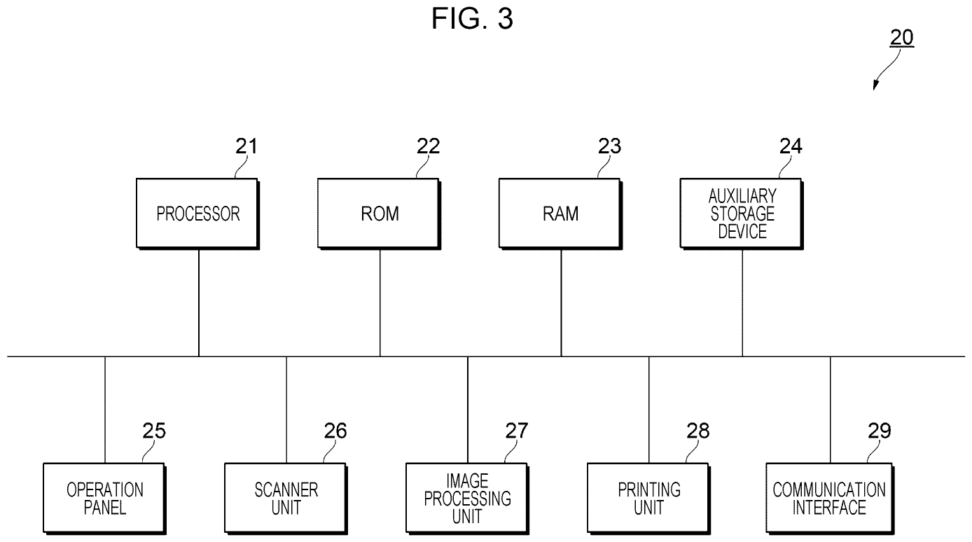

FIG. 3 is a diagram illustrating an example of the hardware configuration of the printer 20.

The printer 20 includes a processor 21, a ROM 22 in which a BIOS, firmware, and the like are stored, a RAM 23 used as a work area of the processor 21, and an auxiliary storage device 24. The printer 20 also includes an operation panel 25 (see FIG. 1), a scanner unit 26, an image processing unit 27, a printing unit 28, and a communication interface 29.

The processor 21 is a device that implements various functions through execution of firmware. The processor 21, the ROM 22, and the RAM 23 function as a computer.

The auxiliary storage device 24 includes, for example, a hard disk device and a semiconductor storage. For example, a print job and an image of a document are stored in the auxiliary storage device 24.

The operation panel 25 is a user interface (UI) that a user operates in accordance with display and includes, for example, a touch panel (see FIG. 1). The operation panel 25 may be called a UI.

The scanner unit 26 includes, for example, a light source that radiates illumination light to a document, an image sensor that captures an image of the document, and a mechanism for transporting the document.

The image processing unit 27 is a processing unit that performs, for example, color correction, gradation correction, and other image processes on a print job and an image of a document.

The printing unit 28 is a mechanism unit that forms an image on paper by, for example, an electrophotographic system or an inkjet system.

The communication interface 29 is an interface that implements communication with the server 10. The communication interface 29 transfers data of a document read by the scanner unit 26 to the server 10. Furthermore, the communication interface 29 receives print data from a user terminal, which is not illustrated in drawings. Communication may be implemented in a wired or wireless manner.

The communication interface 29 supports various communication standards. The communication standards include, for example, Ethernet, Wi-Fi, and a mobile communication system.

Next, a functional configuration of the printer 20 will be described.

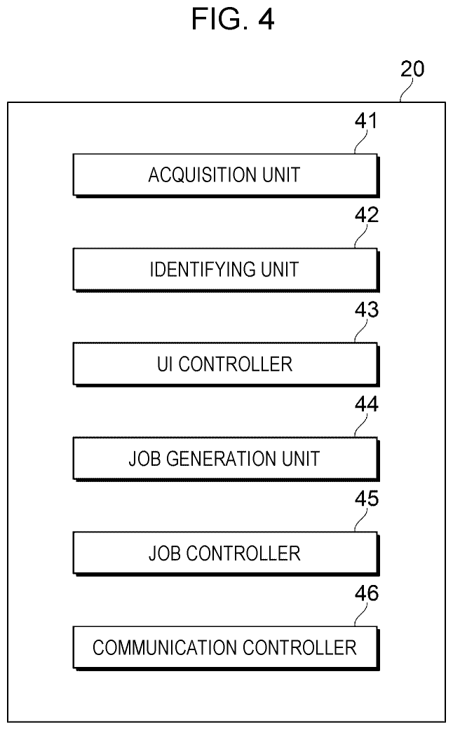

FIG. 4 is a block diagram illustrating an example of the functional configuration of the printer 20.

As illustrated in FIG. 4, the printer 20 includes an acquisition unit 41, an identifying unit 42, a UI controller 43, a job generation unit 44, a job controller 45, and a communication controller 46.

The acquisition unit 41 acquires a print image of a document to be printed. The print image of a document may be acquired by reading of an image or may be acquired by reception from a user terminal, which is not illustrated in drawings.

The identifying unit 42 identifies an image part and a body part in the print image of the document acquired by the acquisition unit 41. As described above, the body part is a part other than the image part in the document and includes, for example, a title.

The UI controller 43 creates a screen to be presented to the user in accordance with the image processing service and displays the screen on the operation panel 25. Furthermore, the UI controller 43 receives information such as an instruction for a process in the image processing service input by an operation on the operation panel 25.

More particularly, the UI controller 43 creates a screen on which the status of a job is displayed and various job parameters and a job are designated and then displays the created screen on the operation panel 25. Furthermore, the UI controller 43 sets parameters of a job and starts the job in accordance with an operation on the operation panel 25.

The job generation unit 44 generates a job based on information received by the UI controller 43. Furthermore, the job generation unit 44 generates a job for printing a print image of a document acquired by the acquisition unit 41. Furthermore, the job generation unit 44 generates a job for printing a print image including a replacement image generated by the image processing service.

The job controller 45 performs control and issues an instruction regarding the job generated by the job generation unit 44 to an apparatus. Furthermore, the job controller 45 performs control and issues an instruction regarding the instruction for the job received from the UI controller 43 to an apparatus. The job controller 45 also notifies the UI controller 43 of the current status of the job.

The communication controller 46 controls communication among the servers 10A to 10C. Furthermore, in the case where a user terminal, which is not illustrated in drawings, is connected to the printer 20, the communication controller 46 controls communication with the user terminal.

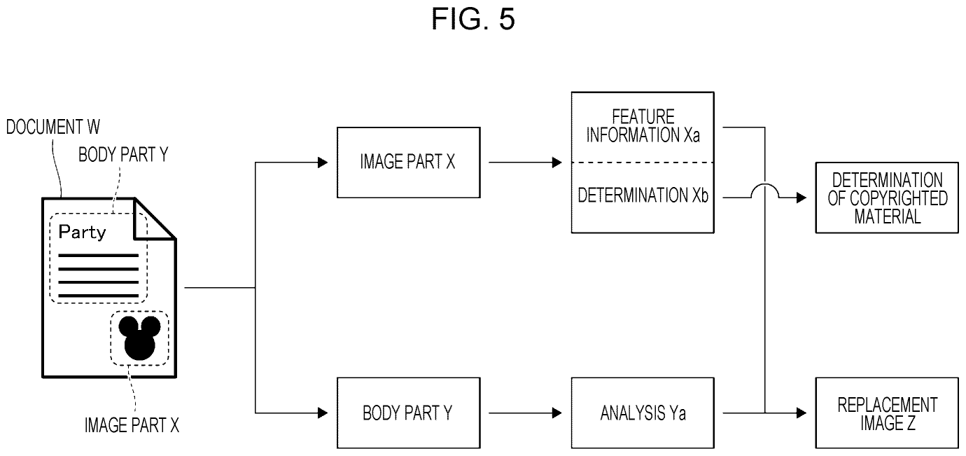

FIG. 5 is a diagram for explaining a determination of a copyrighted material and generation of a replacement image Z based on an image part X and a body part Y in a document W to be printed. The image part X is an example of an image as a copyrighted material, the body part Y is an example of a part other than the image, and the replacement image Z is an example of a different image.

As illustrated in FIG. 5, the image part X and the body part Y in the document W are identified. Furthermore, feature information Xa of the image is extracted from the identified image part X, and a determination Xb as to whether or not the image part X is a copyrighted material is performed.

Identification of the image part X and the body part Y is performed by the identifying unit 42 (see FIG. 4), as described above. Furthermore, extraction and the determination Xb of the feature information Xa are performed by the server 10A (see FIG. 1).

As illustrated in FIG. 5, an analysis Ya of the identified body part Y is performed. The analysis Ya is performed by the server 10B (see FIG. 1).

The feature information Xa is an example of an extracted feature of an image, and the analysis Ya is an example of an analysis of a part other than the image in the document.

Based on the feature information Xa of the image part X and the analysis Ya of the body part Y, the replacement image Z is generated. Generation of the replacement image Z is performed by the server 10C (see FIG. 1). The replacement image Z may be a non-copyrighted material or may be an image that is not a copyrighted material but has a low degree of similarity with respect to a copyrighted material. The replacement image Z may be, for example, an image for which a condition of use is lower than that of the image part X.

Furthermore, the determination as to whether or not the image part X is a copyrighted material is performed based on the determination Xb of the image part X. In this determination, a copyrighted material is not limit to a “copyrighted material of art” such as a character. A copyrighted material may be, for example, a “copyrighted material of a picture” obtained by taking a photograph of illustration of a character. Furthermore, a copyrighted material may be an image representing a copyrighted material of other types, such as a “copyrighted material of language.”

The determination of a copyrighted material is performed by the server 10A (see FIG. 1).

More particularly, in the case where the image part X is, for example, a copyrighted material that is a famous character head, for example, information such as “mouse,” “black,” and “silhouette” is extracted as the feature information Xa. Furthermore, in the case where the image part X is a copyrighted material that is the whole body of a character, pose information such as “standing” and “welcoming pose” may be extracted.

Furthermore, the analysis Ya of the body part Y is performed, for example, as described below.

Because the title of the body part Y is “Party”, information such as “party” is acquired. Furthermore, elements are extracted from a part of the body part Y other than the title, based on chapter information, document structure, and the end-of-sentence representation. Furthermore, a summary may be created from text in the part other than the title and elements may be extracted from the created summary.

For example, elements corresponding to features such as “Reality/Fiction,” “Official/Casual,” and “Natural/Artificial” and feature element quantities of the elements are determined.

In the case of the body part Y in the document W illustrated in FIG. 5, as the analysis Ya, for example, a result “Reality: 01” is obtained. That is, as a result of the analysis Ya, a feature “Reality” and a feature element quantity “01”, which is low, are obtained. The analysis Ya may be one analysis or may include a plurality of analyses.

Furthermore, by the determination Xb as to whether or not the image part X is a copyrighted material, the image part X may be determined, based on the image determination, to be a “copyrighted material” with an image matching rate of 100% or may be determined, based on the image determination, to be an image similar to a “copyrighted material” with an image matching rate of less than 100%. In the latter case, by the determination Xb, a result “highly likely to be a copyrighted material” may be obtained or a result “unlikely to be a copyrighted material” may be obtained.

A threshold value may be used to determine whether or not the possibility of a copyrighted material. A user may be able to change the threshold value. Furthermore, in a modification, in the case where the threshold value is not exceeded, a definitive determination result such as “not a copyrighted material” may be obtained.

### First Exemplary Embodiment

Next, the image processing system 1 according to a first exemplary embodiment will be described.

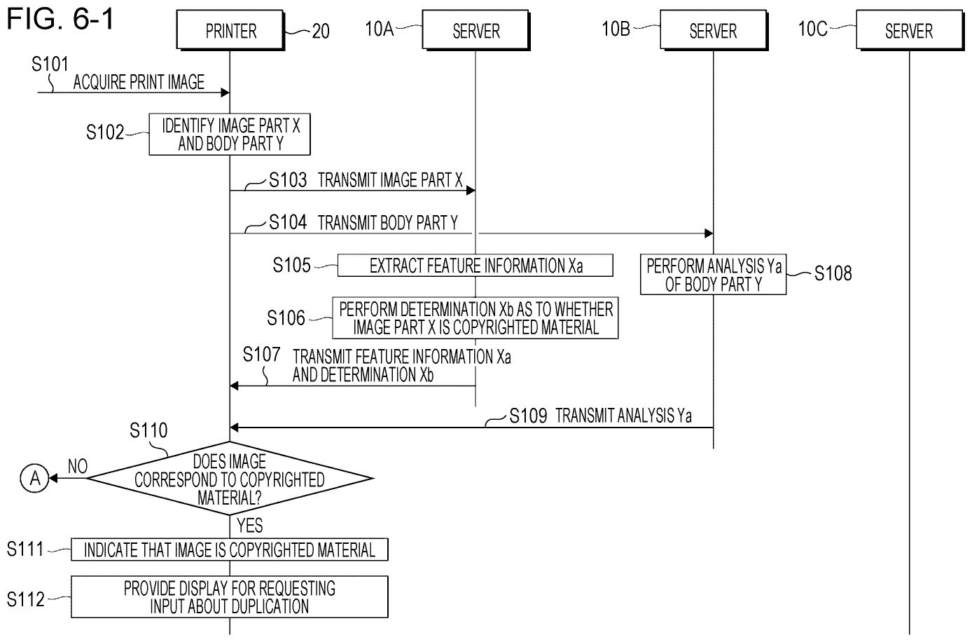

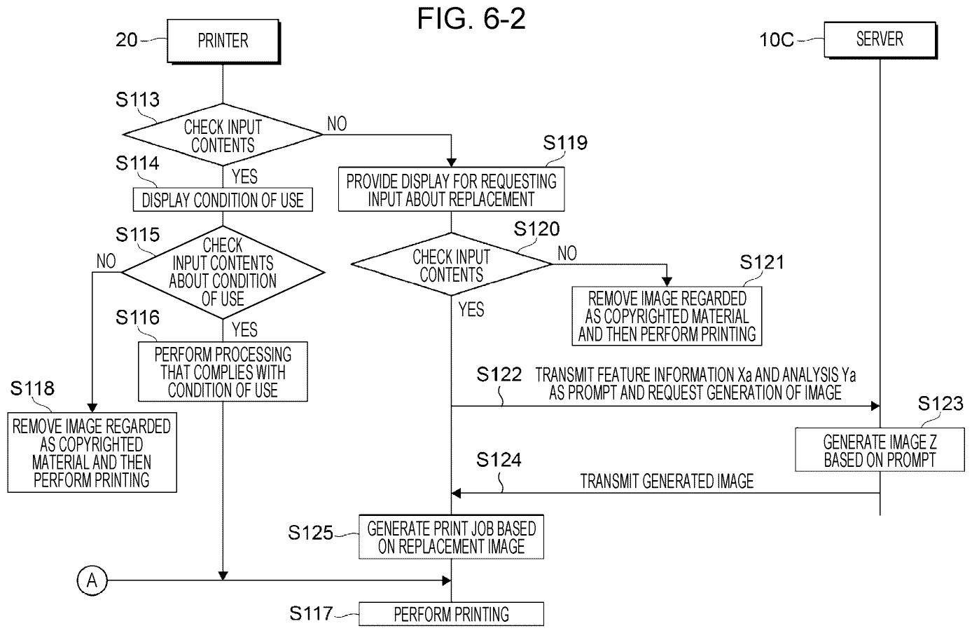

FIGS. 6-1 and 6-2 are sequence diagrams illustrating a sequence example in the first exemplary embodiment. In FIG. 6-1, the printer 20, the server 10A as the image determination AI, the server 10B as the text determination AI, and the server 10C as the image generation AI are illustrated in this order from the left. In FIG. 6-2, the printer 20 and the server 10C are illustrated. Furthermore, in FIG. 6-1, steps up to step 112 are illustrated. In FIG. 6-2, step 113 and the remaining steps are illustrated. Therefore, FIG. 6-1 and FIG. 6-2 may be genetically referred to as FIG. 6.

In the sequence example illustrated in FIG. 6, first, the acquisition unit 41 of the printer 20 (see FIG. 4) acquires a print image that a user wishes to print (step 101). The acquisition of the print image is performed by image reading by the printer 20 or reception by a user terminal, which is not illustrated in drawings.

The identifying unit 42 of the printer 20 (see FIG. 4) identifies the image part X and the body part Y in the print image (step 102).

The image part X is a target of, for example, a determination as to whether or not an image is a copyrighted material. As described above, the body part Y includes the title and text in the document to be printed and may also be regarded as a text part.

The communication controller 46 of the printer 20 (see FIG. 4) transmits data of the identified image part X to the server 10A (step 103). Furthermore, the communication controller 46 transmits data of the identified body part Y to the server 10B (step 104).

The server 10A extracts feature information Xa of the image from the received data of the image part X (step 105). Furthermore, the server 10A performs the determination Xb as to whether or not the image part X is a copyrighted material (step 106).

The server 10A transmits the extracted feature information Xa and the executed determination Xb to the printer 20 (step 107).

The server 10B performs the analysis Ya of the body part Y using the received data of the body part Y (step 108).

The server 10B transmits the executed analysis Ya to the printer 20 (step 109).

After receiving the feature information Xa and the determination Xb from the server 10A and receiving the analysis Ya from the server 10B, the printer 20 performs the next processing. That is, the printer 20 checks, based on the determination Xb, whether or not the image corresponds to a copyrighted material (step 110).

In the case where the result of the determination Xb is that the image corresponds to a copyrighted material (Yes in step 110), the UI controller 43 of the printer 20 (see FIG. 4) presents on the operation panel 25 (for example, see FIG. 3) a display indicating that the image is a copyrighted material (step 111). Furthermore, the UI controller 43 presents on the operation panel 25 a display for requesting the user to provide an input about whether or not to perform duplication including the copyrighted material (step 112). The display in step 111 and the display in step 112 may be presented on different screens or may be presented on the same screen.

In the case where a user terminal, which is not illustrated in drawings, is connected, instead of the display on the operation panel 25 or along with the display on the operation panel 25, the display may be presented on the user terminal.

The UI controller 43 (see FIG. 4) checks contents of the input by the user about duplication (step 113). In the case where the contents of the input indicate execution of duplication including the copyrighted material (Yes in step 113), a display of a condition of use of the copyrighted material is presented on the operation panel 25 (for example, see FIG. 3) (step 114). The display of the condition of use includes contents that request an input about whether or not the condition of use will be accepted.

The UI controller 43 (see FIG. 4) checks contents of the input by the user about the condition of use (step 115).

In the case where the contents of the input indicate acceptance of the condition of use (Yes in step 115), the job generation unit 44 and the job controller 45 (see FIG. 4) perform processing that complies with the condition of use (step 116). The processing that complies with the condition of use is set in advance. For example, the processing may be charging or addition of a display indicating that the image is a copyrighted material.

Then, the job generation unit 44 (see FIG. 4) generates a job, and the job controller 45 (see FIG. 4) performs printing of the generated job (step 117).

In the case where the contents of the input about the condition of use indicate rejection of the condition of use (No in step 115), the job generation unit 44 and the job controller 45 (see FIG. 4) perform processing for removing the image determined to be a copyrighted material and then performing printing (step 118). In this case, the UI controller 43 (see FIG. 4) may remove the image from the operation panel 25 (for example, see FIG. 3) and then perform printing.

In step 118 described above, instead of the processing for removing the image determined to be a copyrighted material and then performing printing, processing for canceling printing may be performed. In this case, cancellation of printing may be notified on the operation panel 25 (for example, see FIG. 3).

Explanation be resumed from step 113.

In the case where the contents of the input by the user about duplication indicate rejection of the condition of use (No in step 113), the UI controller 43 (see FIG. 4) presents a display for requesting an input about replacement (step 119). That is, a display for requesting an input about whether or not to replace the copyrighted material with a replacement image is presented.

The UI controller 43 (see FIG. 4) checks contents of the input by the user about replacement with a replacement image (step 120).

In the case where the contents of the input indicate rejection of replacement with a replacement image (No in step 120), the job generation unit 44 and the job controller 45 (see FIG. 4) perform processing for removing the image determined to be a copyrighted material and then performing printing (step 121). The processing of step 121 is the same as the processing of step 118 described above.

In the case where the contents of the input about replacement with a replacement image indicate acceptance of replacement with a replacement image (Yes in step 120), the communication controller 46 (see FIG. 4) requests the server 10C to generate an image (step 122). In more detail, the feature information Xa and the analysis Ya are transmitted as a prompt to be used for generation of the replacement image Z (see FIG. 5) in the server 10C.

The server 10C generates the replacement image Z based on the prompt (step 123). The generated image is transmitted to the printer 20 (step 124).

The request for generation of the replacement image Z and transmission of the generated image may be performed once or may be performed a plurality of times. That is, the printer 20 does not necessarily acquire the replacement image Z once. The printer 20 may acquire the replacement image Z a plurality of times.

When receiving the replacement image Z generated by the server 10C, the job generation unit 44 of the printer 20 (see FIG. 4) generates a print job based on the replacement image Z (step 125). That is, the job generation unit 44 generates a print job in which the region of the image part X in the document to be printed has been replaced with the replacement image Z.

The job controller 45 (see FIG. 4) performs printing based on the generated print job (step 117).

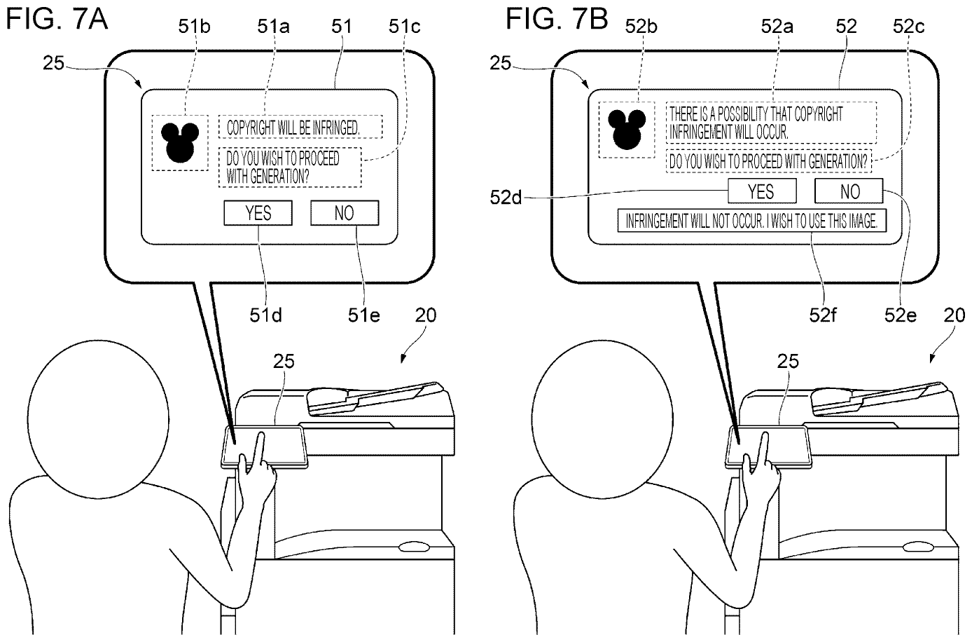

FIG. 7A is a diagram for explaining a display example 51 of the operation panel 25 of the printer 20, and FIG. 7B is a diagram for explaining a display example 52 of the operation panel 25 of the printer 20.

The display example 51 illustrated in FIG. 7A is a display presented on the operation panel 25 when the printer 20 receives a result of a determination about a document from the server 10A as the image determination AI (see FIG. 1). More particularly, the display example 51 is an example of the case where the displays presented in steps 111, 112, and 119 in the sequence diagrams described above are presented on the same screen.

The display example 51 illustrated in FIG. 7A includes a region 51a for notifying the user of a determination result “Copyright will be infringed.” and a region 51b in which an image as a determination target is indicated. Furthermore, the display example 51 also includes a region 51c for asking the user a question “Do you wish to proceed with generation?”

Furthermore, the display example 51 includes a region 51d in which a button image “Yes” is indicated and a region 51e in which a button image “No” is indicated.

An operation performed on “Yes” in the region 51d corresponds to Yes in step 120 in FIG. 6-2 described above. An operation performed on “No” in the region 51e corresponds to No in step 120 in FIG. 6-2 described above.

The display example 52 illustrated in FIG. 7B includes a region 52a for notifying the user of a determination result “There is a possibility that copyright infringement will occur.” and a region 52b in which the image as the determination target is indicated. Furthermore, the display example 52 also includes a region 52c for asking the user a question “Do you wish to proceed with generation?”

Furthermore, the display example 52 includes a region 52d in which a button image “Yes” is indicated and a region 52e in which a button image “No” is indicated. Furthermore, the display example 52 also includes a region 52f in which a button image “Infringement will not occur. I wish to use this image.” is indicated.

The regions 52b to 52e correspond to the regions 51b to 51e in the display example 51 illustrated in FIG. 7A.

In the case where the button image in the region 52f is operated, the processing for presenting the display for requesting the user for an input about whether or not to perform duplication including the copyrighted material (step 112 in FIG. 6-1) and the later processing may be omitted. In this case, printing of the print job (step 117 in FIG. 6-2) may be performed immediately.

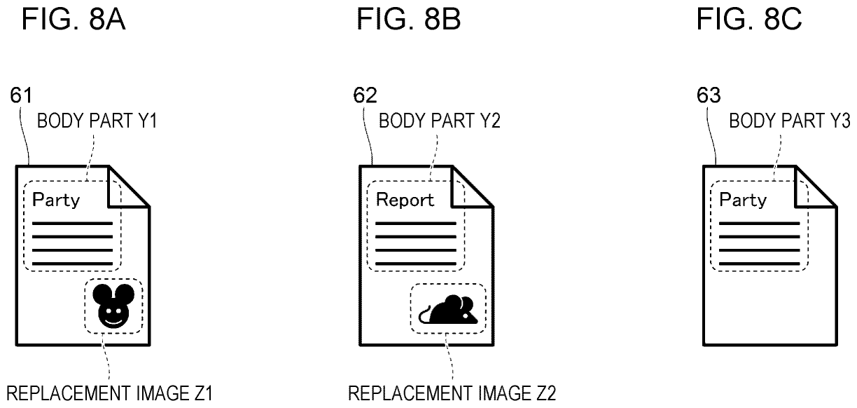

FIG. 8A is a diagram for explaining a first printing example 61 as a printed material in which a document to be printed is printed, FIG. 8B is a diagram for explaining a second printing example 62 as a printed material in which a document to be printed is printed, and FIG. 8C is a diagram for explaining a third printing example 63 as a printed material in which a document to be printed is printed. In the cases illustrated in FIGS. 8A, 8B, and 8C, the document to be printed includes the image part X illustrated in FIG. 5 and the image part X is a copyrighted material.

The first printing example 61 illustrated in FIG. 8A is, for example, a casual printed material such as a party flyer, as is clear from a body part Y1. Thus, in the first printing example 61, a replacement image Z1 generated as a casual image with a low degree of Reality and the body part Y1 are printed.

The second printing example 62 illustrated in FIG. 8B is an academic printed material such as a report, as is clear from a body part Y2. Thus, in the second printing example 62, a replacement image Z2 generated as an image with a high degree of Reality and the body part Y2 are printed. The replacement image Z2 is different from the replacement image Z1 illustrated in FIG. 8A.

The third printing example 63 illustrated in FIG. 8C is a printed material obtained by removing the image regarded as a copyrighted material and then performing printing in the case where an instruction to replace the copyrighted material with a different image is not received (see steps 118 and 121 in FIG. 6-2). Thus, in the third printing example 63, only a body part Y3 is printed.

### Second Exemplary Embodiment

Next, the image processing system 1 according to a second exemplary embodiment will be described.

In the second exemplary embodiment, a configuration for changing a replacement image (for example, see the replacement image Z1 in FIG. 8A) generated by the server 10C (for example, see FIG. 6) is provided. The second exemplary embodiment is basically similar to the first exemplary embodiment described above but is different from the first exemplary embodiment in that the configuration mentioned above is provided.

A replacement image is changed by the UI controller 43 (see FIG. 4).

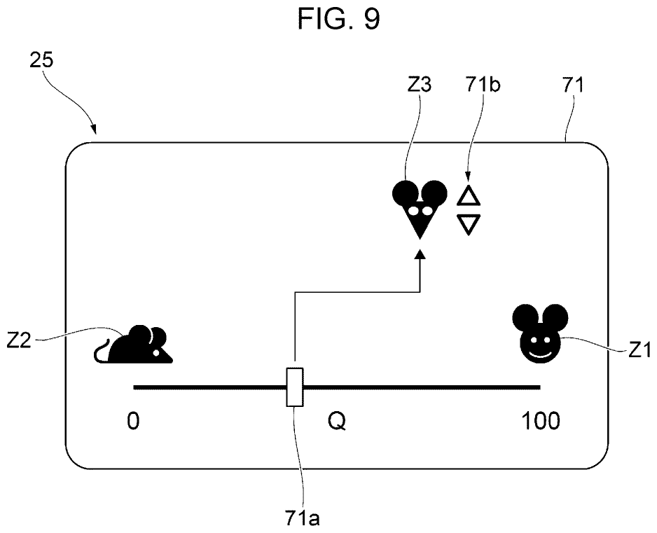

FIG. 9 is a diagram for explaining a display example 71 of the operation panel 25 in the second exemplary embodiment.

In the display example 71 illustrated in FIG. 9, a slide bar 71a that is movable along a sliding part extending in the horizontal direction is illustrated. The slide bar 71a is provided to change a feature quantity Q by a manual operation by a user and the numeric value is variable between “0” and “100.”

Furthermore, in the display example 71 in FIG. 9, a position change unit 71b for changing the position of the slide bar 71a is illustrated. The position change unit 71b includes an upward button for increasing the feature quantity Q and a downward button for decreasing the feature quantity Q. By changing the position of the slide bar 71a using the position change unit 71b, the value of the feature quantity Q changes. The slide bar 71a is regarded as being used to set weighting information. In a modification, a numeric value may be input, instead of using the slide bar 71a.

More particularly, in the display example 71 in FIG. 9, the replacement image Z2 (see FIG. 8B) is illustrated as an image for the case where the numeric value of the feature quantity Q is “0.” Furthermore, the replacement image Z1 (see FIG. 8A) is illustrated as an image for the case where the numeric value of the feature quantity Q is “100.” Furthermore, a replacement image Z3 corresponding to the feature quantity Q indicated by the slide bar 71a is also illustrated in the display example 71. In the display example 71, a preview function is provided.

In the display example 71 illustrated in FIG. 9, by operating the position change unit 71b, the value of the feature quantity Q changes. As the value of the feature quantity Q changes, display of the replacement image Z3 changes. When the replacement image Z3 is set by the user, the printer 20 requests the server 10C to generate the set replacement image Z3 (see step 122 in FIG. 6-2).

As described above, the user is able to change the feature quantity Q by manually operating the slide bar 71a. The feature quantity Q is changed by such an operation by the user, and an image closer to a desired image is able be set as a replacement image. The feature quantity Q relates to the feature information Xa or the feature element quantity of an image. The feature quantity Q is an example of information indicating a feature extracted from an image and an example of information set by a numeric value.

The feature quantity Q may relate to the feature information Xa and the analysis Ya. In this case, the feature information Xa and the analysis Ya may be changed by an operation on the slide bar 71a by the user.

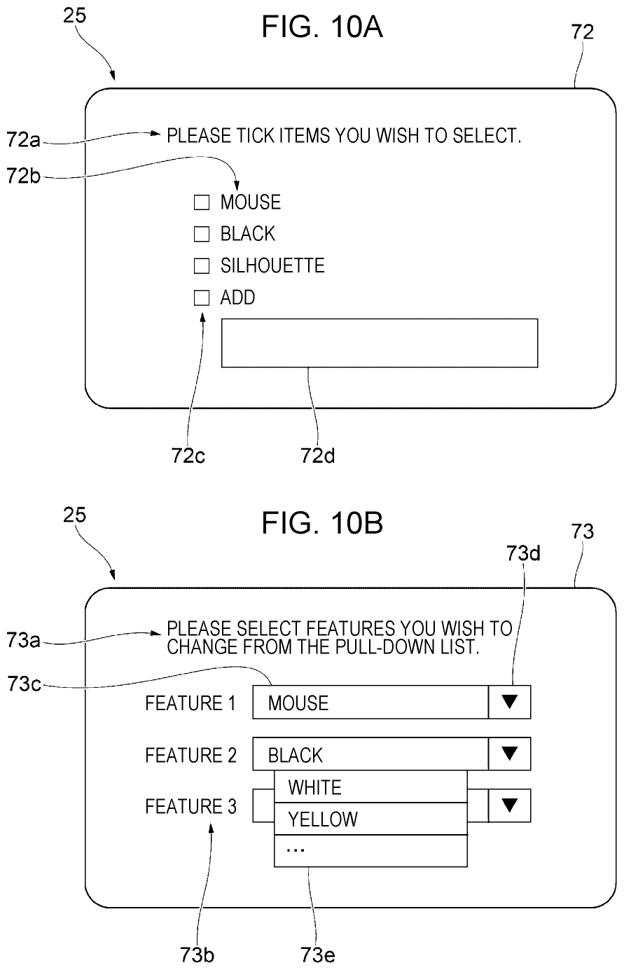

FIG. 10A is a diagram for explaining a display example 72 of the operation panel 25 in the second exemplary embodiment, and FIG. 10B illustrates a display example 73 of the operation panel 25 in the second exemplary embodiment. In the display examples 72 and 73, the user directly changes feature information Xa.

In the display example 72 illustrated in FIG. 10A, a representation 72a “Please tick items you wish to select.” is indicated. Furthermore, in the display example 72, a representation 72b including items “mouse,” “black,” and “silhouette” as the feature information Xa extracted by the server 10B (see FIG. 1) and an item “add” for the case where the user wishes to add something as the feature information Xa is indicated. The representation 72b is defined by a representation using a natural language. The representation 72b is an example of information indicating a feature extracted from an image.

Furthermore, in the display example 72, checkboxes 72c corresponding to the items in the representation 72b are indicated. With the checkboxes 72c, a plurality of items may be selected. That is, the user is able to perform an operation for ticking an item or items that the user wishes to use from among the plurality of items in the representation 72b and not ticking an item or items that the user does not wish to use. Thus, the feature information Xa used to generate the replacement image Z (for example, see FIG. 5) may be changed.

Furthermore, in the display example 72, an input region 72d is indicated. The input region 72d is a region in which the user is able to enter letters when a checkbox 72c corresponding to “add” in the representation 72b is ticked. The user is able to use a new item as the feature information Xa by using the input region 72d.

As described above, in the display example 72, by performing an operation, the user is able to make changes, such as deletion and addition, to the feature information Xa extracted from the image part X (for example, see FIG. 5).

Although the case of the feature information Xa is indicated in the display example 72, the present disclosure is not limited to the case described above. That is, the user may be able to change the analysis Ya (for example, see FIG. 5) about the body part Y by the server 10B (see FIG. 1), as in the case of the display example 72.

In the display example 73 illustrated in FIG. 10B, a representation 73a “Please select features you wish to change from the pull-down list.” is indicated. Furthermore, in the display example 73, a representation 73b including items “feature 1,” “feature 2,” and “feature 3” is indicated. Furthermore, in the display example 73, a representation 73c including “mouse” and “black”, which are part of or all the pieces of feature information Xa extracted by the server 10B (see FIG. 1), is indicated. Furthermore, in the display example 73, pull-down buttons 73d are indicated next to corresponding items of the representation 73c.

The display example 73 illustrated in FIG. 10B represents a state in which a pull-down button 73d corresponding to “black” in the representation 73c is operated, and a pull-down menu 73e is indicated. The pull-down menu 73e includes options such as “white” and “yellow.” The pull-down menu 73e is an example of a list of options set based on one of the plurality of items.

Thus, the user is able to change, for example, “black” in the feature information Xa into another color. As described above, in the display example 73, the user is able to directly change the extracted feature information Xa.

Although the case of the feature information Xa is indicated in the display example 73, the present disclosure is not limited to the case described above. That is, the user may be able to change the analysis Ya (for example, see FIG. 5) about the body part Y by the server 10B (see FIG. 1), as in the case of the display example 73.

### Various Modifications of Second Exemplary Embodiment

Although a replacement image is changed by changing the feature quantity Q in the second exemplary embodiment, the present disclosure is not limited to this configuration.

For example, in a modification, a seed value may be changed. The seed value mentioned above is a random value provided in generation of an image. In the case where an image is generated by specifying a seed value, the same image is able to be reproduced. Both the seed value and the feature quantity described above may be used. Furthermore, by specifying only a feature quantity or by specifying only a seed value, an image generated after change may be acquired. A seed value may be specified automatically or manually.

Acquisition of a replacement image in this modification is an example of acquisition in a case where a seed value provided in generation of an image is specified.

Furthermore, in a modification, the server 10C that is to be requested for generation of a replacement image may be selected based on characteristics of a plurality of servers. In more detail, the printer 20 may select, based on the feature information Xa and the analysis Ya, a server to be requested for generation of a replacement image. Furthermore, the user may be able to select a server. This is because attention is paid to the feature that every server generates a different image.

For example, in an aspect, the user may check a replacement image generated by the default server 10C, switch to another server, and request again the server for generation of a replacement image. Furthermore, in an aspect, the user may perform, based on the feature information Xa and the analysis Ya, switching of a server that generates a replacement image.

Acquisition of a replacement image in this modification is an example of acquisition in a case where an apparatus that generates a different image is specified. More particularly, a replacement image may be acquired by one of or both of the case where an apparatus that generates a different image is specified and the case where a seed value that is provided in generation of an image is specified as described above.

Furthermore, in another modification, a similar image may be generated by adding history information on past usage to a prompt. The past usage history may be based on, for example, the history linked with an account used by the user.

Acquisition of a replacement image in this modification is implemented using history information corresponding to a feature and an analysis result.

### Application Example of First Exemplary Embodiment or Second Exemplary Embodiment

An application example of a case where a document W to be printed includes a plurality of pages will be described.

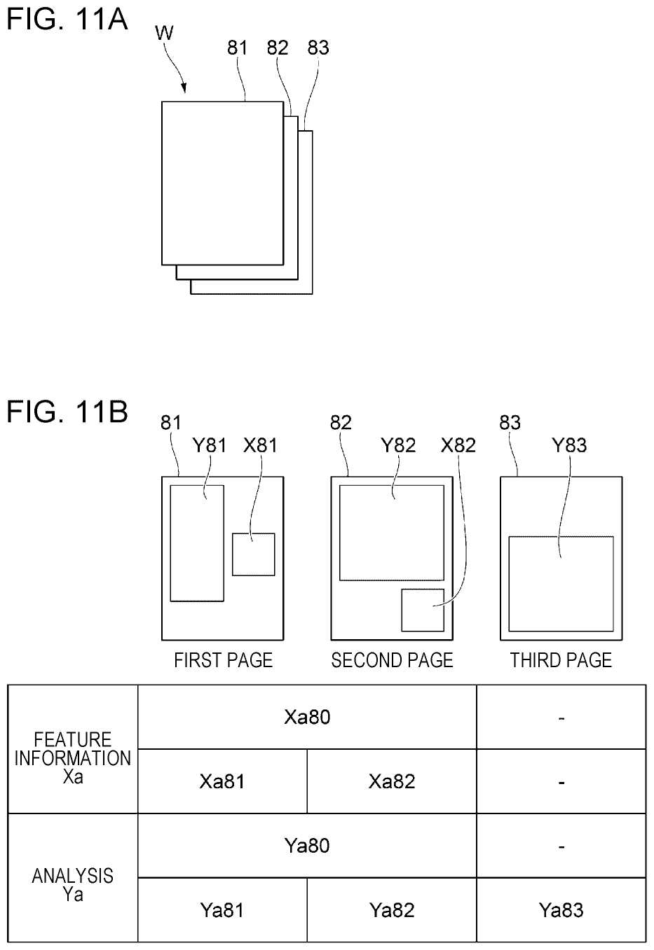

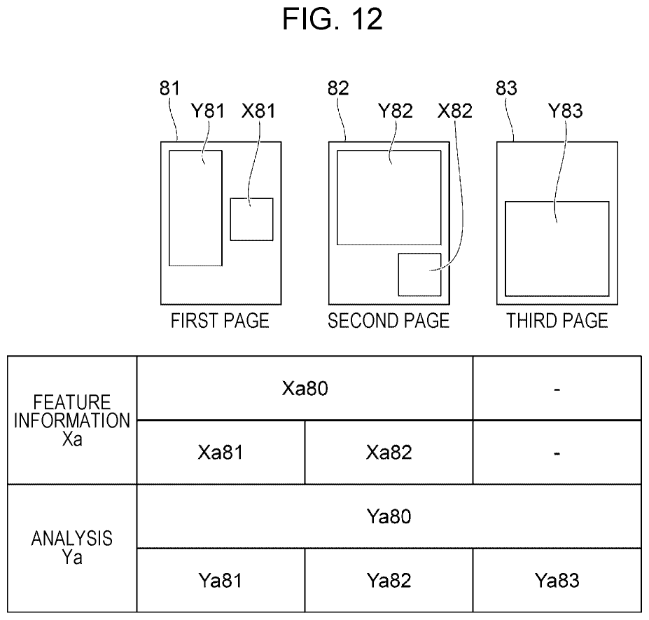

FIGS. 11A and 11B and FIG. 12 are diagrams for explaining an application example. FIG. 11A illustrates a case where the document W to be printed includes a plurality of pages. FIGS. 11B and 12 are diagrams for illustrating pages of the document to be printed. FIG. 11B illustrates an example of the pages of the document W, and FIG. 12 illustrates another example of the pages of the document W.

As illustrated in FIG. 11A, in this example, the document W to be printed includes documents of three pages: a document 81 corresponding to the first page, a document 82 corresponding to the second page, and a document 83 corresponding to the third page. This application example may also be applied to a case where the document W to be printed includes four or more pages.

In the example illustrated in FIG. 11B, the document 81 corresponding to the first page includes an image part X81 and a body part Y81. The document 82 corresponding to the second page includes an image part X82 and a body part Y82.

The document 83 corresponding to the third page includes a body part Y83. The document 83 corresponding to the third page does not include an image part. This application example may also be applied to a case where the document 83 corresponding to the third page includes an image part.

Extraction of the feature information Xa and the analysis Ya are performed on the document W including a plurality of pages.

As illustrated in FIG. 11B, the extracted feature information Xa includes feature information Xa80 that is in common between the documents 81 and 82. That is, the common feature information Xa80 is extracted based on the image parts X81 and X82.

Furthermore, the feature information Xa includes individual feature information Xa81 about the image part X81 and individual feature information Xa82 about the image part X82.

Furthermore, as illustrated in FIG. 11B, the analysis Ya includes an analysis Ya80 that is in common between the body parts Y81 and Y82 of the documents 81 and 82. That is, the common analysis Ya80 is obtained based on the body parts Y81 and Y82.

Furthermore, the analysis Ya includes an individual analysis Ya81 about the body part Y81, an individual analysis Ya82 about the body part Y82, and an individual analysis Ya83 about the body part Y83.

The common feature information Xa80 and the common analysis Ya80 are an example of information that is in common among a plurality of pages. The individual feature information Xa81 and Xa82 and the individual analyses Ya81, Ya82, and Ya83 are an example of information for each page.

For generation of the replacement image Z for the image parts X81 to X82 of the documents 81 to 82, the common feature information Xa80, the individual feature information Xa81 to Xa82, the common analysis Ya80, and the individual analyses Ya81 to Ya82 described above are used.

In more detail, for generation of the replacement image Z1 for the image part X81, the common feature information Xa80, the individual feature information Xa81, the common analysis Ya80, and the individual analysis Ya81 are used. For generation of the replacement image Z2 for the image part X82, the common feature information Xa80, the individual feature information Xa82, the common analysis Ya80, and the individual analysis Ya82 are used.

Thus, regarding the replacement images Z1 and Z2, compared to the case where the replacement images Z are generated only based on the individual feature information Xa81 and Xa82, consistency between the document 81 corresponding to the first page including an image and the document 82 corresponding to the second page including an image is ensured.

More particularly, it may be considered that the common feature information Xa80 and the common analysis Ya80 have the same degree of impact on acquisition of the replacement images Z1 and Z2 as that of the individual feature information Xa81 and Xa82 and the individual analyses Ya81, Ya82, and Ya83.

Furthermore, it may be considered that the common feature information Xa80 and the common analysis Ya80 have a higher degree of impact on acquisition of the replacement images Z1 and Z2 than that of the individual feature information Xa81 and Xa82 and the individual analyses Ya81, Ya82, and Ya83. The importance of a common feature quantity is prioritized.

Furthermore, it may be considered that the common feature information Xa80 and the common analysis Ya80 have a lower degree of impact on acquisition of the replacement images Z1 and Z2 than that of the individual feature information Xa81 and Xa82 and the individual analyses Ya81, Ya82, and Ya83.

Although a replacement image is generated based on the feature information Xa and the analysis Ya in FIG. 11B, the present disclosure is not limited to this configuration. A replacement image may be generated based on only the feature information Xa.

In the example illustrated in FIG. 12, the same document as the document W in the example illustrated in FIG. 11B is used. That is, the document 83 corresponding to the third page does not include an image part.

In the example illustrated in FIG. 12, the extracted feature information Xa includes the feature information Xa80 that is in common between the documents 81 and 82. Furthermore, the analysis Ya includes the analysis Ya80 that is in common among the body parts Y81, Y82, and Y83 of the documents 81, 82, and 83. That is, in the example illustrated in FIG. 12, the analysis Ya includes not only the body parts Y81 and Y82 but also the body part Y83 of the document 83, which does not include an image part. In this respect, the example illustrated in FIG. 12 is different from the example illustrated in FIG. 11B.

Thus, regarding the replacement images Z1 and Z2, compared to the example illustrated in FIG. 11B, consistency among the document 81 corresponding to the first page, the document 82 corresponding to the second page, and the document 83 corresponding to the third page is ensured.

### Third Exemplary Embodiment

Next, the image processing system 1 according to a third exemplary embodiment will be described. Description and illustration of configuration features in the third exemplary embodiment that are in common to those in the first exemplary embodiment described above will be omitted.

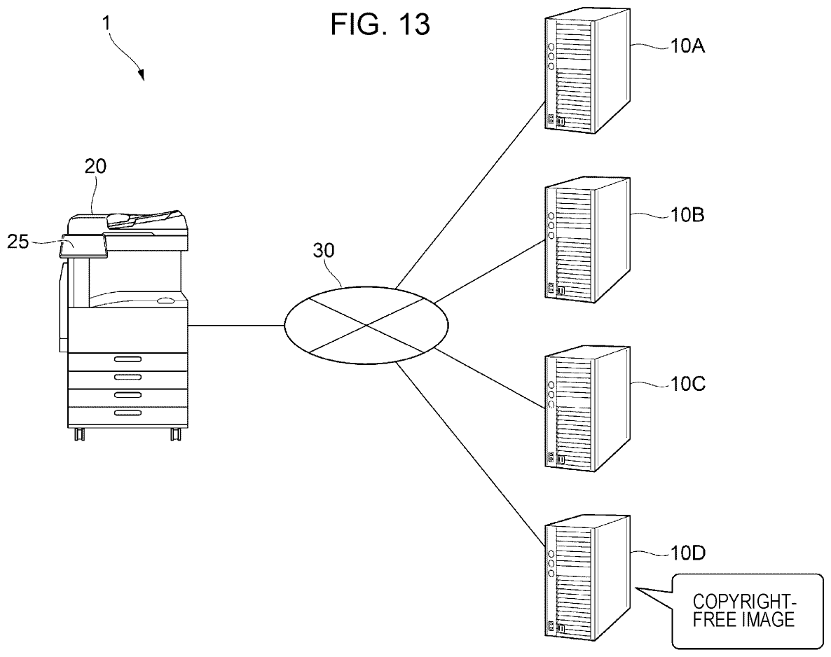

FIG. 13 is a diagram for explaining the image processing system 1 according to the third exemplary embodiment and corresponds to FIG. 1 for explaining an exemplary embodiment.

As illustrated in FIG. 13, the image processing system 1 according to the third exemplary embodiment includes the servers 10A to 10C and further includes a server 10D. Since the image processing system 1 according to the third exemplary embodiment includes the server 10D, the third exemplary embodiment is different from the image processing system 1 according to the exemplary embodiment (see FIG. 1) that does not include the server 10D.

The server 10D is a database that stores copyright-free images. A copyright-free image represents an image that is free from copyright restrictions and may be, for example, an image available on the Internet. A copyright-free image may be an image for which the copyright protection period has expired.

A copyright-free image is an example of an image that is able to be used for free without permission for use and without restrictions on use.

When receiving the feature information Xa, the analysis Ya, and a request for image search from the printer 20, the server 10D searches the database on the basis of the feature information Xa and the analysis Ya, and acquires a corresponding copyright-free image. The server 10D transmits the acquired image to the printer 20.

More particularly, in FIG. 6, which illustrates the sequence example in the first exemplary embodiment, the printer 20 transmits the feature information Xa and the analysis Ya to the server 10C and requests the server 10C to generate an image (see step 122 in FIG. 6-2). In contrast, in the third exemplary embodiment, a replacement image is acquired by database search by the server 10D, instead of requesting generation of an image.

Thus, the printer 20 is able to acquire a copyright-free image as a replacement image, and the effectiveness against copyright infringement is improved.

Although exemplary embodiments of the present disclosure have been described above, the technical scope of the present disclosure is not limited to the scope described in the exemplary embodiments. It is obvious from the scope of the claims that various changes or improvements made to the exemplary embodiments are also included in the technical scope of the present disclosure.

The present disclosure is also applicable to a program and a program product.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image processing system comprising:
a processor configured to:
   in a case where an image as a copyrighted material included in a document to be printed is replaced with a different image,
   extract a feature of the image;
   analyze a part other than the image in the document; and
   acquire, based on the extracted feature and a result of the analysis, the different image.
      (((2)))

The image processing system according to (((1))), wherein information indicating the extracted feature is defined by a representation using a natural language.

(((3)))

The image processing system according to (((1))), wherein information indicating the extracted feature is defined by a numeric value.

(((4)))

The image processing system according to any one of (((1))) to (((3))), wherein information indicating the extracted feature is able to be changed by an operation by a user.

(((5)))

The image processing system according to any one of (((1))) to (((3))), wherein information indicating the extracted feature and the result of the analysis is able to be changed by an operation by a user.

(((6)))

The image processing system according to (((4))) or (((5))), wherein the information is defined by any one of a plurality of items.

(((7)))

The image processing system according to any one of (((1))) to (((6))), wherein the different image is able to be acquired a plurality of times by specifying a seed value provided in generation of an image and/or specifying an apparatus that generates the different image.

(((8)))

The image processing system according to (((1))),
wherein in a case where the document to be printed includes a plurality of pages,
the feature and the result of the analysis include common information that is in common among the plurality of pages and individual information for each of the plurality of pages, and
based on the common information and the individual information, the different image as a replacement in a page corresponding to the individual information is acquired.
   (((9)))

The image processing system according to (((8))), wherein the common information is information about pages that include the image out of the plurality of pages.

(((10)))

The image processing system according to (((8))),
wherein in a case where the plurality of pages include a page that does not include the image,
the common information is information about the plurality of pages including the page that does not include the image.
   (((11)))

The image processing system according to (((9))) or (((10))), wherein a degree of an impact of the common information on acquisition of the different image is higher than a degree of an impact of the individual information on the acquisition of the different image.

(((12)))

The image processing system according to (((1))), wherein the different image is acquired by searching for an image that is able to be used for free without permission for use and without restrictions on use.

(((13)))

The image processing system according to (((1))), wherein the different image is acquired based on history information corresponding to the feature and the result of the analysis.

(((14)))

An image processing apparatus that replaces an image as a copyrighted material included in a document to be printed with a different image, the image processing apparatus comprising:
means for extracting a feature of the image;
means for analyzing a part other than the image in the document; and
acquiring, based on the extracted feature and a result of the analysis, the different image.
   (((15)))

A program causing an information processing apparatus to execute;
in a case where an image as a copyrighted material included in a document to be printed is replaced with a different image,
extracting a feature of the image;
analyzing a part other than the image in the document; and
acquiring, based on the extracted feature and a result of the analysis, the different image.

What is claimed is:

1. An image processing system comprising:
a processor configured to:
in a case where an image as a copyrighted material included in a document to be printed is replaced with a different image,
extract a feature of the image;
analyze a part other than the image in the document; and
acquire, based on the extracted feature and a result of the analysis, the different image.

2. The image processing system according to claim 1, wherein information indicating the extracted feature is defined by a representation using a natural language.

3. The image processing system according to claim 1, wherein information indicating the extracted feature is defined by a numeric value.

4. The image processing system according to claim 1, wherein information indicating the extracted feature is able to be changed by an operation by a user.

5. The image processing system according to claim 1, wherein information indicating the extracted feature and the result of the analysis is able to be changed by an operation by a user.

6. The image processing system according to claim 4, wherein the information is defined by any one of a plurality of items.

7. The image processing system according to claim 1, wherein the different image is able to be acquired a plurality of times by specifying a seed value provided in generation of an image and/or specifying an apparatus that generates the different image.

8. The image processing system according to claim 1,
wherein in a case where the document to be printed includes a plurality of pages,
the feature and the result of the analysis include common information that is in common among the plurality of pages and individual information for each of the plurality of pages, and
based on the common information and the individual information, the different image as a replacement in a page corresponding to the individual information is acquired.

9. The image processing system according to claim 8, wherein the common information is information about pages that include the image out of the plurality of pages.

10. The image processing system according to claim 8,
wherein in a case where the plurality of pages include a page that does not include the image,
the common information is information about the plurality of pages including the page that does not include the image.

11. The image processing system according to claim 9, wherein a degree of an impact of the common information on acquisition of the different image is higher than a degree of an impact of the individual information on the acquisition of the different image.

12. The image processing system according to claim 1, wherein the different image is acquired by searching for an image that is able to be used for free without permission for use and without restrictions on use.

13. The image processing system according to claim 1, wherein the different image is acquired based on history information corresponding to the feature and the result of the analysis.

14. An image processing apparatus that replaces an image as a copyrighted material included in a document to be printed with a different image, the image processing apparatus comprising:
an extraction unit that extracts a feature of the image;
an analysis unit that analyzes a part other than the image in the document; and
an acquisition unit that acquires, based on the extracted feature and a result of the analysis, the different image.

15. A non-transitory computer readable medium storing a program causing a computer to execute a process for information processing, the process comprising:
in a case where an image as a copyrighted material included in a document to be printed is replaced with a different image,
extracting a feature of the image;
analyzing a part other than the image in the document; and
acquiring, based on the extracted feature and a result of the analysis, the different image.
